(19) United States
(12) Patent Application Publication
(10) Pub. No.: US 2013/0107546 A1
(43) Pub. Date: May 2, 2013

(54) LED LAMP

(71) Applicant: Matthias Peter, Regensburg (DE)

(72) Inventor: Matthias Peter, Regensburg (DE)

(21) Appl. No.: 13/808,517

(22) PCT Filed: Jun. 29, 2011
(86) PCT No.: PCT/EP2011/060933

§ 371 Date: Jan. 4, 2013

(30) Foreign Application Priority Data
Jul. 6, 2010 (DE) 102010031008.5

(51) Int. Cl. F21V 19/00; F21V 29/00; F21V 15/01

(52) U.S. Cl. CPC F21V 19/0005; F21V 15/01; F21V 29/22
USPC 362/368

(57) ABSTRACT

A light having a lamp housing (8) having a receptacle (6), which receptacle is adapted for receiving a socket (2) for a halogen pin-base lamp (1), wherein a heat sink (102) having thermal contact with the lamp housing (8), and on which an LED (101) is fastened, is at least sectionally received in the receptacle (6).

### TECHNICAL AREA

The invention is directed to a light which is provided for one or more sockets for halogen pin-base lamps.

### PRIOR ART

Lights with halogen pin-base lamps, which are inserted into corresponding sockets, are known from the prior art. The halogen pin-base lamp and the socket can correspond, e.g., to the IEC 60432 standard G9. The socket is inserted into a receptacle of a light housing.

Such lights have the disadvantage of a short lifetime of the lamps of less than 2000 hours, which makes it necessary to replace them frequently.

### SUMMARY OF THE INVENTION

The object of the present invention is to lengthen the lamp replacement interval duration and to increase the efficiency of such lights.

This object is achieved by a light according to patent claim 1.

Particularly advantageous embodiments are found in the dependent claims.

The light according to the invention has a light housing having a receptacle, which receptacle is suitable for receiving or inserting, respectively, a socket of a halogen pin-base lamp. The socket and the halogen pin-base lamp can particularly have the designation G9 according to the IEC 60432 standard. According to the invention, alternatively to the socket with pin-base lamp, a heat sink having good thermal contact with the lamp housing, and on which one or more LEDs are fastened, is received or inserted in the receptacle. Such lights have a lifetime lengthened to 10 000 to 50 000 hours in relation to those with halogen pin-base lamps. Furthermore, the efficiency of LEDs is increased in relation to halogen lamps. Of course, the LEDs can also be indirectly connected to the heat sink via further fastening means.

It is preferable if the LED is an Oslon® LED (1 W), which is produced by the applicant. It offers good efficiency with good light quality.

In a preferred refinement, the LED is fastened on a printed circuit board (e.g., PCB), which is in turn fastened, in particular screwed, onto the heat sink. A heat conduction paste is arranged between each printed circuit board and the heat sink to improve the heat transfer, so that a junction temperature Tⱼ of the LED can be at most 100° C. in the operating state.

Particularly good heat conduction is made possible if the printed circuit board is a metal core printed circuit board. The junction temperature Tⱼ of the LED is decreased further to values <100° C.

In a preferred exemplary embodiment, the heat sink has an approximately pyramidal section, which has multiple, in particular four contact regions each having one printed circuit board per contact region. The contact regions are each inclined by 10 to 40° in relation to a center axis. The emission behavior of a G9 Halopin® lamp of the applicant which is to be replaced is thus optimally replicated.

To improve the heat conduction, in a first variant, the heat sink can consist of brass and can be sectionally screwed via a fine thread into a recess of the light housing. The heat sink is thus in good thermal contact with the light housing.

In another variant, the heat sink also consists of brass and is sectionally screwed via a fine thread into a brass sleeve, which is received in a recess of the light housing. The heat sink is thus also in good thermal contact with the light housing.

To improve the heat transfer from the brass sleeve via the recess to the light housing, a heat conduction paste can be arranged between an outer wall of the brass sleeve and an inner wall of the recess.

If the light according to the invention is formed based on a socket for a halogen light, in which the receptacle is formed by a plastic mount, the plastic mount does not have to be removed to form the light according to the invention. The plastic mount can at least sectionally encompass the heat sink and can be glued to the brass sleeve.

It is preferable if the light is a chandelier having at least three, preferably six recesses, in each of which a brass sleeve having a plastic mount fastened thereon is received, in each of which a heat sink is received. A lampshade can be fastened on an outer thread of each plastic mount.

Two strands, which are connected in parallel, of multiple, in particular respectively 12 LEDs, can preferably be supplied by a power source (preferably 700 mA, 35 W) via a power equalization circuit. Thermal divergence of the two strands is thus prevented.

Each strand can be operated with 350 mA, and a power equalization circuit can be provided, which prevents thermal divergence of the strands.

A light housing having good thermal conductivity, e.g., made of aluminum or stainless steel or metal, is preferred.

### BRIEF DESCRIPTION OF THE DRAWINGS

The invention will be explained in greater detail hereafter on the basis of an exemplary embodiment. In the figures:

FIG. 1 shows a detail of a light having a halogen pin-base lamp according to the prior art in an illustration in partial section;

FIG. 2 shows a first exemplary embodiment of a light according to the invention in a perspective view from below; and

FIG. 3 shows a detail of the first exemplary embodiment of a light according to the invention according to FIG. 2 in an illustration in partial section.

### PREFERRED EMBODIMENT OF THE INVENTION

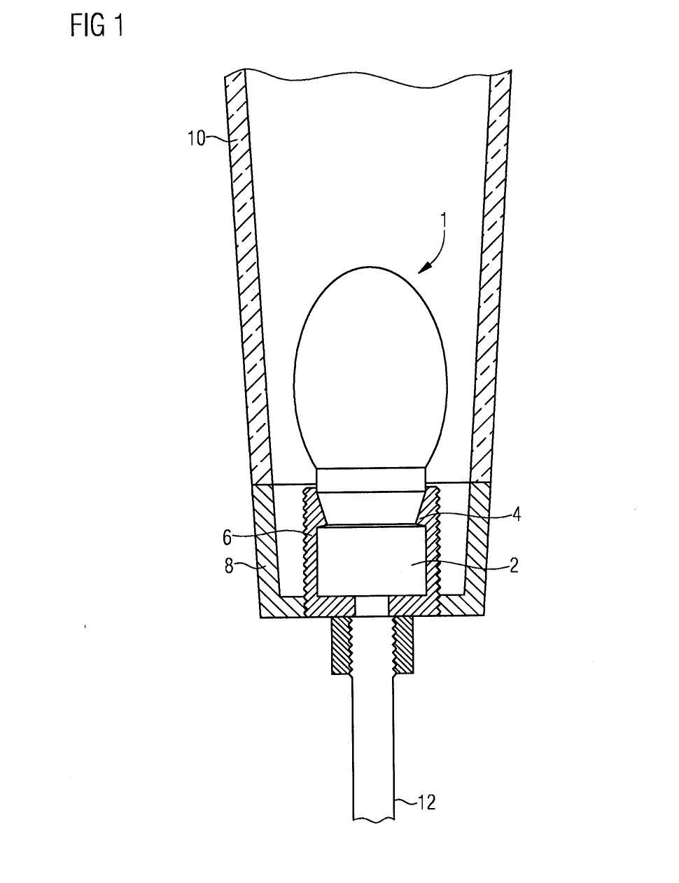

FIG. 1 shows a detail of a light according to the prior art having a halogen pin-base lamp 1 in an illustration in partial section. The halogen pin-base lamp 1 is a Halopin® lamp of the applicant. It has a power consumption of 25 W and bears the designation G9 according to the IEC 60432 standard. The halogen pin-base lamp 1 is inserted into a ceramic socket 2, which corresponds to the same standard.

The ceramic socket 2 is inserted into a cup-shaped plastic mount 6 and secured therein via a clamp mount 4.

The plastic mount 6 is inserted into a metallic cup-shaped housing section 8 of the light and fastened therein. The plastic mount 6 has an external thread, which holds a glass lampshade 10, approximately in the form of a truncated cone, which is used as a light diffuser, and which is only partially shown in FIG. 1. The lampshade 10 is placed on a peripheral edge of the housing section 8.

On a side of the housing section 8 opposite the lampshade 10, a metallic curved housing tube 12 is fastened, only a part of which is shown in FIG. 1.

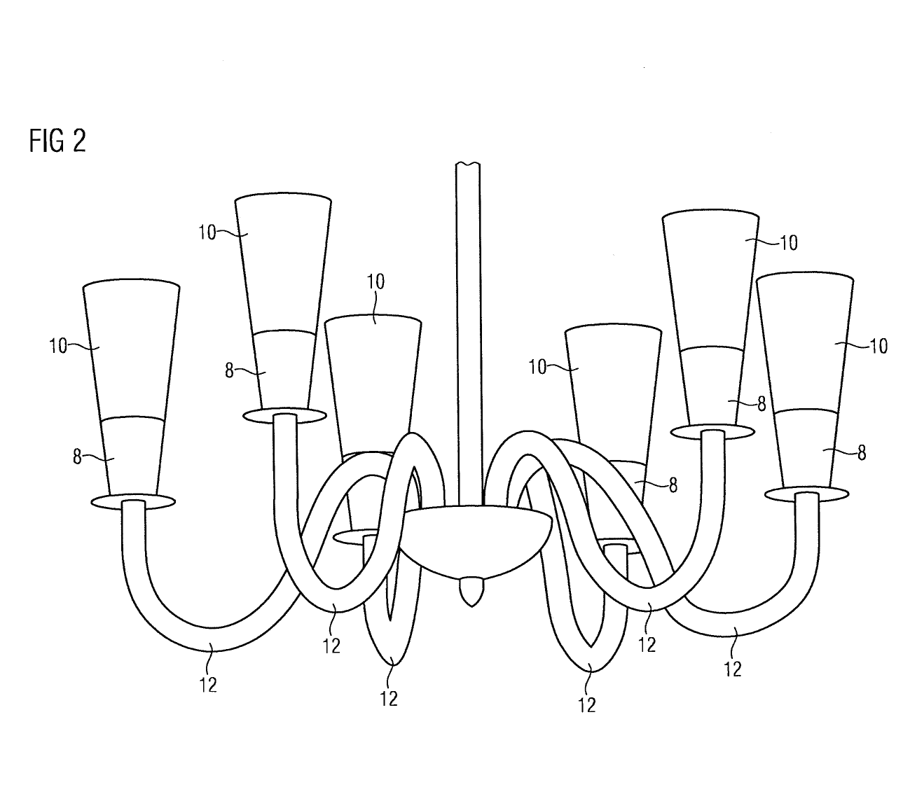

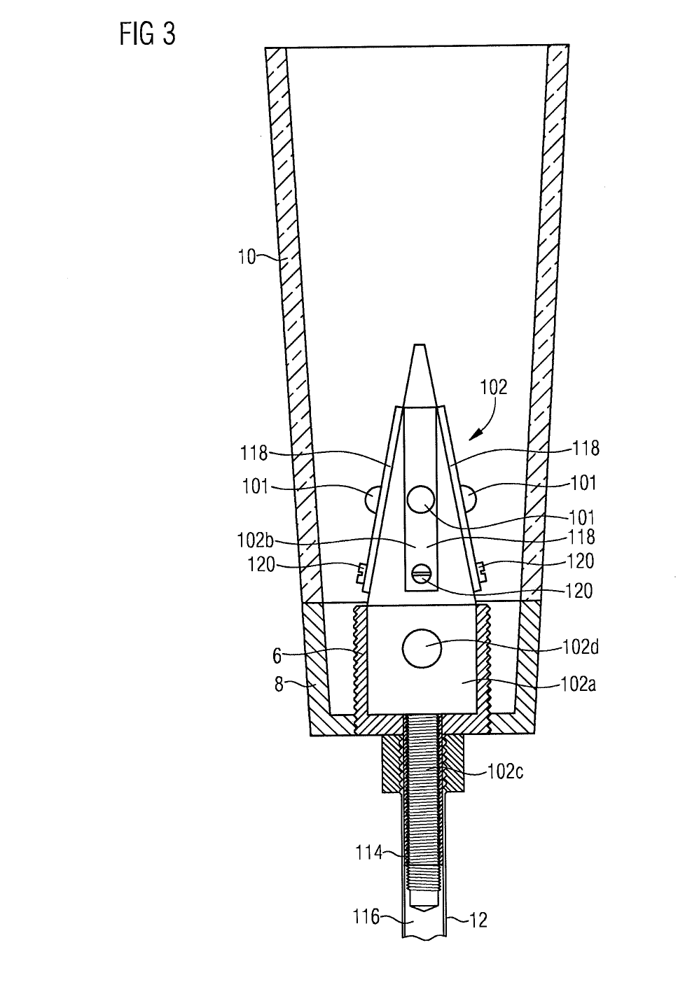

FIG. 2 shows a first exemplary embodiment of a light according to the invention in a perspective view from below. Six cup-shaped housing sections 8 having corresponding lampshades 10 are fastened on the light according to the invention such that they form a chandelier. The respective curved housing tubes 12 are fastened on a middle section of the light. The curved housing tubes 12, the housing sections 8, and the lampshades 10 of the light according to the invention correspond to those of the prior art shown in FIG. 1. According to the invention, instead of the halogen pin-base lamps, LEDs are provided in the interior of the lampshades 10, which are explained with reference to FIG. 3.

FIG. 3 shows a detail of the first exemplary embodiment of the light according to the invention according to FIG. 2 in an illustration in partial section. Only the differences from the arrangement according to the prior art shown in FIG. 1 are explained hereafter.

A brass sleeve 114 is inserted into a through-recess of a base section of a cup-shaped plastic mount 6 and press-fit or glued therein with the plastic mount 6. On the inner circumference of the brass sleeve 114, a fine thread is arranged, into which a corresponding hollow-cylindrical threaded section 102c consisting of brass is screwed. Said threaded section is formed in one piece with a radially expanded cylindrical section 102a, on whose side facing away from the threaded section 102c (on top in FIG. 3), a pyramidal section 102 is attached in one piece. The three sections 102a, 102b, and 102c consist of brass and together form a heat sink 102. The cylindrical section 102a is inserted into the plastic mount 6 and screwed together with the brass sleeve 114 via the threaded section 102c. The brass sleeve 114 is press-fit in a recess 116 formed by the housing tube 12 and provided with heat conduction paste for better thermal contact.

The pyramidal section 102b has four contact surfaces, on each of which a printed circuit board 118 is fastened using a screw 120. An Oslon® LED (1 W) 101 of the applicant having a power consumption of 350 mA is arranged on each printed circuit board 118. The four LEDs 101 are connected in series and are supplied with current by a (+/−) cable (not shown). The cable extends through the recess 116 and through a longitudinal bore (not shown) of the cylindrical section 102a and therefore also through the brass sleeve 114. The cable extends further through a bore hole 102d in the cylindrical section 102a and is connected to two of the four printed circuit boards 118 because of the series circuit. The terminals are either soldered or are connected via a plug connection (not shown) for simpler replaceability of the heat sink 102.

Heat conduction paste is arranged in each case between the printed circuit boards 118 and the pyramidal section 102b as well as between the brass sleeve 114 and the recess 116 of the housing tube 12. The heat generated by the Oslon® LEDs 101 can thus be dissipated via the heat sink 102 and via the fine thread between the threaded section 102c and the brass sleeve 114 to the housing tube 12.

By simply unscrewing the threaded section 102c out of the brass sleeve 114, the heat sink 102 having the printed circuit boards 118 and the Oslon® LEDs 101 can be easily removed from the light according to the invention and inserted again. The light according to the invention (cf. FIG. 2) is therefore equipped with a total of 24 Oslon® LEDs 101, a 700 mA power source (not shown) operating two parallel LED strands each having 12 Oslon® LEDs 101, which prevents thermal divergence of the two strands via a power equalization circuit.

The light according to the invention has, at a color temperature CCT of 3000 K, a light yield of at least 1500 lm/35 W=40 lm/W at a junction temperature Tⱼ of 100° C. Therefore, an at least five-fold increase in efficiency is therefore provided in relation to a comparable light from the prior art according to FIG. 1.

If a metal core printed circuit board is used as the printed circuit board 118 and if the latest generation of Oslon® LEDs are used, the following two examples result for the increase in efficiency of the light according to the invention in relation to a halogen light according to the prior art:

92 lm@RT/3000 K→70 lm@90-95° C.→

24*70 lm˜1700 lm/35 W=50 lm/W→

Seven-fold increase in efficiency at 3000 K (warm white, halogen equivalent)or

120 lm@RT/5500 K→90 lm@90-95° C.→

24*90 lm˜2160 lm/35 W=62 lm/W→

Nine-fold increase in efficiency at 6500 K (cold white, colder than halogen)

Of course, other embodiments of the invention are also conceivable, in particular other forms of the light, for example chandeliers having more or fewer arms, but also wall lights, ceiling lights, installed lights, etc. Pyramidal sections having more or fewer contact surfaces than shown are also conceivable, in particular having three contact surfaces.

1. A light having a lamp housing having a receptacle, which receptacle is adapted for receiving a socket for a halogen pin-base lamp, wherein a heat sink having thermal contact with the lamp housing, and on which an LED is fastened, is at least sectionally received in the receptacle.

2. The light as claimed in claim 1, wherein the LED is an Oslon® LED.

3. The light as claimed in claim 1, wherein the LED is fastened on a printed circuit board, which is fastened on the heat sink, and a heat conduction paste is arranged between the printed circuit board and the heat sink.

4. The light as claimed in claim 3, wherein the printed circuit board is a metal core printed circuit board.

5. The light as claimed in claim 3, wherein the heat sink has an approximately pyramidal section, which has multiple, in particular four contact regions each having one printed circuit board per contact region, which are inclined by 10 to 40° in relation to a center axis.

6. The light as claimed in claim 1, wherein the heat sink consists of brass and is sectionally screwed via a fine thread into a threaded recess of the lamp housing.

7. The light as claimed in claim 1, wherein the heat sink consists of brass and is sectionally screwed via a fine thread into a brass sleeve, which is received in a recess of the lamp housing.

8. The light as claimed in claim 7, wherein a heat conduction paste is arranged between an outer wall of the brass sleeve and an inner wall of the recess.

9. The light as claimed in claim 1, which is a chandelier having at least three recesses in each of which a brass sleeve having a plastic mount fastened thereon, which forms the receptacle, is received, in each of which a heat sink is received.

10. The light as claimed in claim 9, wherein two strands, which are connected in parallel, of multiple LEDs can be supplied by a power source via a power equalization circuit.
